(19) United States
(12) Patent Application Publication
(10) Pub. No.: US 2009/0100040 A1
(43) Pub. Date: Apr. 16, 2009

(54) LAWFUL INTERCEPTION OF BROADBAND DATA TRAFFIC

(76) Inventors: Scott Sheppard, Decatur, GA (US); Stephen Cersosimo, Buford, GA (US); James R. Pennington, Atlanta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 12/062,208

(22) Filed: Apr. 3, 2008

Related U.S. Application Data
(60) Provisional application No. 60/921,510, filed on Apr. 3, 2007.

(51) Int. Cl. G06F 17/30

(52) U.S. Cl. 707/5; 707/E17.059

(57) ABSTRACT

Methods, systems, and computer-readable media provide for lawfully intercepting broadband data traffic. According to one method, a request to retrieve a network address associated with a login identifier is received. An Authentication, Authorization and Accounting (AAA) server is queried based on the login identifier to retrieve the network address associated with the login identifier. Relevant data traffic and AAA information associated with the relevant data traffic is filtered at a network element. The relevant data traffic and the AAA information is forwarded to a law enforcement agency (LEA) system.

### CROSS REFERENCE TO RELATED APPLICATIONS

This application claims the benefit of U.S. provisional patent application No. 60/921,510 entitled “SYSTEMS, METHODS, AND COMPUTER-READABLE MEDIA FOR INTERCEPTING NETWORK TRAFFIC” filed on Apr. 3, 2007, which is expressly incorporated herein by reference.

### BACKGROUND

Lawful interception (e.g., wiretapping) is a common technique used by law enforcement agencies (“LEAs”) to intercept certain communications between parties of interest. Unlike illegal interception, lawful interception is performed in accordance with applicable (e.g., local, state and/or federal) laws. In particular, the communications that are intercepted under lawful interception may be subject to the limitations of due process and other legal considerations (e.g., Fourth Amendment). To further protect the parties of interest, intercepted communications may be authenticated to validate any claims in favor or against the evidence (e.g., that the intercepted communication originated from a particular party, that the communication was intercepted at a particular time).

Lawful interception is usually accomplished with the help and cooperation of a service provider. The duty of the service provider to provide LEAs with access to otherwise private communications is governed by the Communications Assistance for Law Enforcement Act (“CALEA”). As first passed by Congress in 1994, CALEA was primarily concerned with voice communications, such as plain old telephone service (“POTS”) and, more recently, voice over Internet protocol (“VOIP”). However, with the growth of the Internet, LEAs have also sought to intercept data communications transmitted over broadband networks. To this end, CALEA was recently expanded to cover data communications in addition to the traditional voice communications.

Lawful interception of voice communications is generally well known. However, conventional techniques for intercepting voice communications may not be applicable to data communications due, at least in part, to the nature of data communications and its transmission over broadband networks. For example, while access to voice communications remains mostly static (e.g., the location of a landline phone, and in many cases, a VoIP phone, generally remain in a single location), access to the Internet is often dynamic, as evidenced by the increasing availability of Wi-Fi hotspots at airports, coffee shops, and the like. Among other things, these public accessible hotspots increase the difficulty of intercepting broadband communications and associating the intercepted traffic to specific users.

### SUMMARY

Embodiments of the disclosure presented herein include methods, systems, and computer-readable media for lawfully intercepting broadband data traffic. According to one aspect, a method for intercepting broadband data traffic is provided. According to the method, a request to retrieve a network address associated with a login identifier is received. An Authentication, Authorization and Accounting (AAA) server is queried based on the login identifier to retrieve the network address associated with the login identifier. Relevant data traffic and AAA information associated with the relevant data traffic is filtered at a network element. The relevant data traffic and the AAA information is forwarded to a law enforcement agency (LEA) system.

According to another aspect, a system is provided for intercepting broadband data traffic. The system includes a memory and a processor functionally coupled to the memory. The memory stores a program containing code for intercepting broadband data traffic. The processor is responsive to computer-executable instructions contained in the program and operative to receive a request to retrieve a network address associated with a login identifier, query an Authentication, Authorization and Accounting (AAA) server based on the login identifier to retrieve the network address associated with the login identifier, filter relevant data traffic and AAA information associated with the relevant data traffic at a network element, and forward the relevant data traffic and the AAA information to a law enforcement agency (LEA) system.

According to yet another aspect, a computer-readable medium having instructions stored thereon for execution by a processor to perform a method for intercepting broadband data traffic is provided. According to the method, a request to retrieve a network address associated with a login identifier is received. An AAA server is queried based on the login identifier to retrieve the network address associated with the login identifier. Relevant data traffic and AAA information associated with the relevant data traffic is filtered at a network element. The relevant data traffic and the AAA information is forwarded to the LEA system.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a simplified block diagram illustrating a lawful interception system, in accordance with exemplary embodiments.

FIG. 2 is a simplified block diagram illustrating an IP address verification system, in accordance with exemplary embodiments.

FIG. 3 is an exemplary XML formatted reply from one or more RADIUS servers based on a given IP address.

FIG. 4 is a flow diagram illustrating a method for determining a relationship between a login identifier and a network address in a lawful interception system, in accordance with exemplary embodiments.

FIG. 5 is a simplified block diagram illustrating another lawful interception system, in accordance with exemplary embodiments.

FIG. 6 is a flow diagram illustrating a method for intercepting data traffic with a lawful interception system, in accordance with exemplary embodiments.

FIG. 7 is a simplified block diagram illustrating an AAA traffic transport system, in accordance with exemplary embodiments.

FIG. 8 is a flow diagram illustrating a method for collecting AAA traffic along with subscriber data traffic, in accordance with exemplary embodiments.

FIG. 9, a simplified block diagram illustrating a lawful interception system for capturing data traffic at a multi-homed network, in accordance with exemplary embodiments.

FIG. 10 is a flow diagram illustrating a method for collecting AAA traffic along with subscriber data traffic, in accordance with exemplary embodiments.

FIG. 11 is a simplified block diagram illustrating a lawful interception system, in accordance with exemplary embodiments.

FIG. 12 is a flow diagram illustrating a method for generating data traffic to test a lawful interception system, in accordance with exemplary embodiments.

FIG. 13 is a simplified block diagram illustrating a lawful interception system, in accordance with exemplary embodiments.

FIG. 14 is a flow diagram illustrating a method for filtering extraneous data traffic in a lawful interception system, in accordance with exemplary embodiments.

FIG. 15 is a computer architecture diagram showing aspects of an illustrative computer hardware architecture for a computing system capable of implementing aspects of the embodiments presented herein.

### DETAILED DESCRIPTION

The following detailed description is directed to methods, systems, and computer-readable media for configuring and operating a lawful interception system. In the following detailed description, references are made to the accompanying drawings that form a part hereof, and which are shown by way of illustration through specific embodiments or examples.

The standard used for broadband CALEA intercepts is ATIS-1000013.2007s (“T1.IAS”). The T1.IAS standard is used to govern the content, format, and nature of information that is sent to a law enforcement agency during a court ordered intercept of broadband data traffic. The embodiments described herein are based on the T1.IAS standard, but other standards, such as European Telecommunications Standards Institute (“ETSI”) and J-STD-25, may be similarly utilized.

General Interception System Diagram

According to exemplary embodiments, a lawful interception system includes three units: an acquisition function (“AF”) system, a mediation function (“MF”) system, and a collection function (“CF”) system. The AF system may include a group of computers and other devices adapted to observe and collect data traffic associated with a given subscriber or a user of the subscriber's device. The MF system may include a group of computers and other devices adapted to receive the collected data traffic from the AF system, format the collected traffic into a desired arrangement, and merge the formatted data traffic with Authentication, Authorization and Accounting (“AAA”) information to form finalized data traffic. In this disclosure, AAA is described primarily in terms of the Remote Authentication Dial In User Service (“RADIUS”) protocol. It should be appreciated, however, that other AAA protocols, such as Diameter, may be similarly utilized. The CF system may include a group of computers and other devices adapted to receive the finalized data traffic from the MF system. The finalized data traffic gathered at the CF system may be utilized by law enforcement personnel for a variety of law enforcement and legal applications.

The AF system and the MF system may be provided by a broadband service provider in accordance with CALEA requirements. In contrast, the CF system is generally provided and managed by a law enforcement agency (“LEA”), and is beyond the scope of this disclosure. Embodiments described herein provide for configuring and operating the AF system and the MF system with respect to the CF system and in accordance with CALEA requirements.

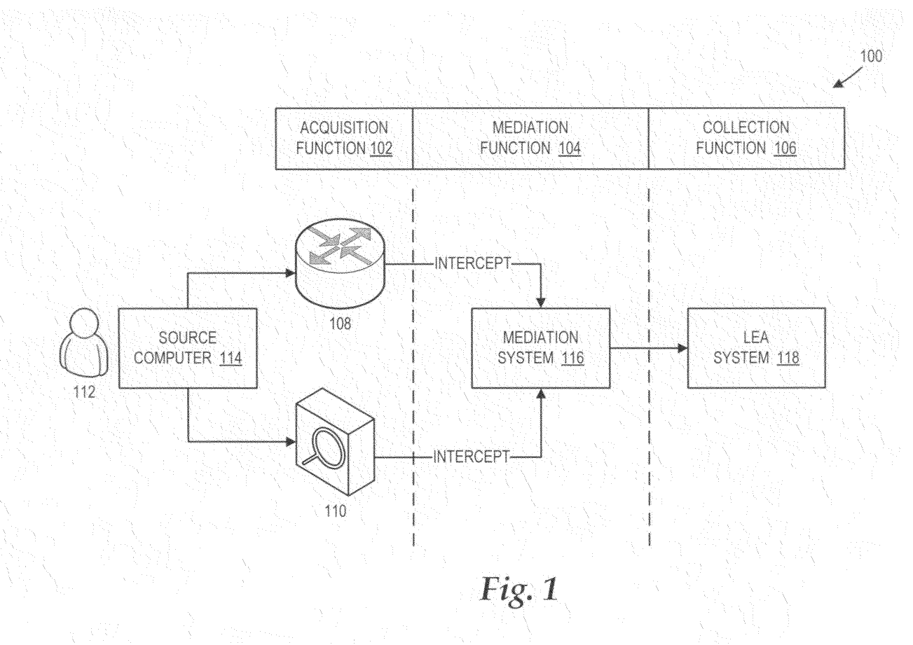

Referring now to FIG. 1, a simplified block diagram illustrating a lawful interception system 100 is shown, in accordance with exemplary embodiments. The lawful interception system 100 is an illustrative configuration of computers and other devices that conforms to CALEA requirements. Other configurations of computers and other devices may be contemplated by those skilled in the art. Other embodiments described in greater detail below may be based on the lawful interception system 100.

As shown in FIG. 1, the lawful interception system 100 includes an AF system 102, a MF system 104, and a CF system 106. The components of these systems are also shown in FIG. 1, separated by dashed lines. As shown in FIG. 1, the AF system 102 may include a network element 108 or a probe 110 that is adapted to intercept data traffic originating from a subscriber 112 or other user via a source computer 114. The network element 108 may be any suitable router or switch capable of intercepting data traffic. For example, CISCO GIGABIT SWITCH ROUTERS (“GSR”) with SERVICE INDEPENDENT INTERCEPT capabilities can be configured to intercept data traffic based on IP address.

The probe 110 may be any suitable device adapted to isolate data traffic based on a source identifier associated with the source computer 114. Examples of such source identifiers may include, but are not limited to, Internet Protocol (“IP”) address, permanent virtual circuit (“PVC”), virtual local area network (“VLAN”), and circuit identification information. The probe 110 may include, for example, a Gigabit Ethernet (“GigE”) probe or an Asynchronous Transfer Mode Optical Carrier-3 (“ATM OC-3”) probe.

Once data traffic is captured at the AF system 102, the data traffic is transmitted from the AF system 102 to the MF system 104. As illustrated in FIG. 1, the MF system 104 includes a mediation system 116. The mediation system 116 may perform a number of different tasks related to the manipulation of the data traffic prior to transmission to the CF system 106. In a first example, the mediation system 116 may match intercepted data traffic to a given subscriber, such as the subscriber 112, or other user of the source computer 114. In a second example, the mediation system 116 may access a RADIUS database via AAA accounting messages to retrieve the IP address of the subscriber 112. In a third example, the mediation system 116 may configure the network element 108 and/or the probe 110 to intercept data traffic based on PVC, IP address, circuit ID, or the like. In a fourth example, the mediation system 116 may merge two separate data streams associated with the subscriber 112 into a single data stream. In this case, each of the separate data streams may pass asymmetrically across two separate network elements.

In a fifth example, the mediation system 116 may integrate AAA data and intercepted data into a format that is supported by the CF system 106. Examples of suitable formats include, but are not limited to, T1.IAS and packet capture (“PCAP”) flat file export. In a sixth example, the mediation system 116 may maintain a keep-alive with the CF system 106 to ensure the availability of transmission links between the mediation system 116 and the CF system 106. In a seventh example, the mediation system 116 caches data bound for the CF system 106 until Transmission Control Protocol (“TCP”) packets transmitted from the mediation system 116 to the CF system 106 are acknowledged and verified as having been received at a given destination IP address. In an eighth example, the mediation system 116 may provide an “audit trail” enabling the broadband service provider and/or the LEA to define, among other things, the type of warrant being served, the duration of the warrant, and any special provisions related to the warrant.

Upon preparing the finalized data traffic, the mediation system 116 may transmit the finalized data traffic to the CF system 106. As illustrated in FIG. 1, the CF system 106 includes a LEA system 118, which is managed by a suitable LEA. In one embodiment, the finalized data traffic is pushed to the LEA system 118. That is, the LEA system 118 does not retrieve the finalized data traffic in this embodiment. In another embodiment, the finalized data traffic is stored on a dedicated storage (not shown). In this way, the LEA system 118 can retrieve the finalized data traffic at its convenience.

Maintaining a Relationship Between a Given Login and Dynamic Network Addresses

As described above, one task of the mediation system 116 is to match data packets to a given subscriber, such as the subscriber 112, or other user of the source computer 114. In one embodiment, each of the data packets is uniquely associated with AAA information, such as a login and password. The AAA information may be used by the subscriber 112 to access a broadband network, such as the Internet, via a network access server (“NAS”). In order to intercept the data traffic associated with the subscriber 112, the AF system 102 may be configured to intercept data traffic associated with the AAA information corresponding to the subscriber 112.

One requirement for some law enforcement agencies regarding the interception of data traffic is the verification of an IP address of the subscriber 112, as well as other information (e.g., AAA start time, NAS IP address), to a particular login. In one embodiment, the IP address is statically assigned and does not change. In other embodiments, the IP address may be dynamically assigned. In particular, the IP address for the source computer 114 can be dynamically assigned via, for example, Dynamic Host Configuration Protocol/Bootstrap Protocol (“DHCP/BOOTP”), Reverse Address Resolution Protocol (“RARP”), and Point-to-Point Protocol Internet Protocol Control Protocol (“PPP IPCP”).

One approach to verify the IP address is to attempt to disconnect the session of the subscriber 112 at a predicted IP address. If the subscriber 112 is successfully disconnected, the subscriber 112 will be forced to log into the broadband network again. This approach is suboptimal because it may alert the subscriber 112 to the intercept or at least the presence of an unusual event. Further, the IP address associated with the source computer 114 may change when the subscriber 112 logs into the broadband network again.

A better approach may be to query one or more RADIUS databases, such as the RADIUS databases (also known as AAA databases) provided by JUNIPER NETWORKS, INC., to verify the relationship between the IP address and the login identification (“ID”), such as a username. The RADIUS database generally stores AAA information associated with the subscriber 112 and enables a RADIUS server to authenticate the subscriber 112 via the login ID and a password. By directly querying one or more RADIUS databases, the MF system 104 can verify the IP address associated with the login ID, assuming this information is available on the RADIUS databases.

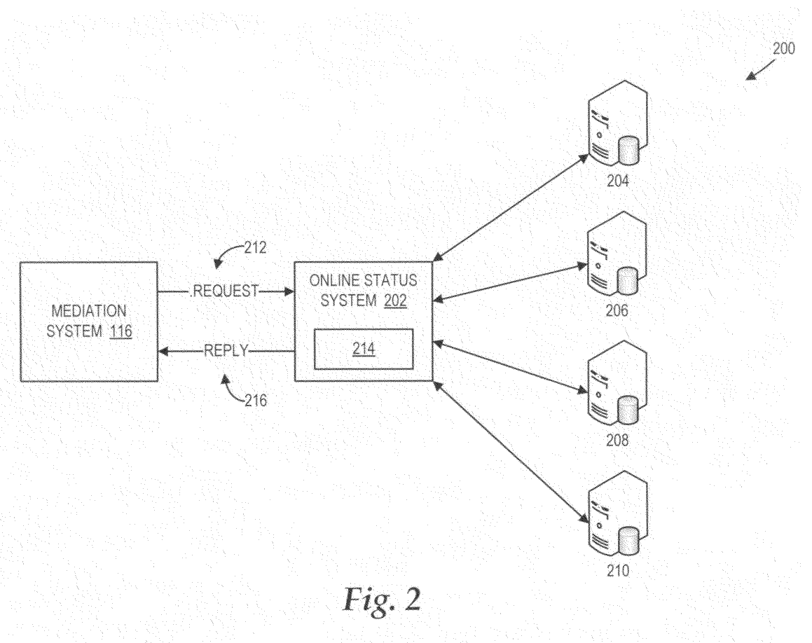

Referring now to FIG. 2, an IP address verification system 200 is shown, in accordance with exemplary embodiments. As illustrated in FIG. 2, the mediation system 116 is operatively coupled to an online status system 202. The online status system 202 is operatively coupled to one or more RADIUS databases, such as a first RADIUS database 204, a second RADIUS database 206, a third RADIUS database 208, and a fourth RADIUS database 210. In one embodiment, each of the RADIUS databases 204, 206, 208, 210 are located in separate locations. The RADIUS databases 204, 206, 208, 210 may be provided by JUNIPER NETWORKS INC., for example.

In an illustrative example, the mediation system 116 transmits a request 212 to the online status system 202 requesting AAA information, such as a login ID, available on the RADIUS databases 204, 206, 208, 210 based on an IP address. In one embodiment, the request 212 is an Extensible Markup Language (“XML”) formatted request transmitted to the online status system 202 via Hypertext Transfer Protocol over Secure Socket Layer (“HTTPS”). Other formats and transmission protocols may be similar utilized.

According to exemplary embodiments, an online status module 214 receives the IP address request 212 and generates a Standard Query Language (“SQL”) query to request the IP address and other AAA information available on one or more of the RADIUS databases 204, 206, 208, 210. If the IP address and other AAA information are available on the RADIUS databases 204, 206, 208, 210, then the online status module 214 receives the IP address and other AAA information in a corresponding SQL reply. The online status module 214 may convert the SQL reply into an XML formatted reply 216. The XML formatted reply 216 may be transmitted from the online status module 214 to the mediation system 116 via HTTPS, for example.

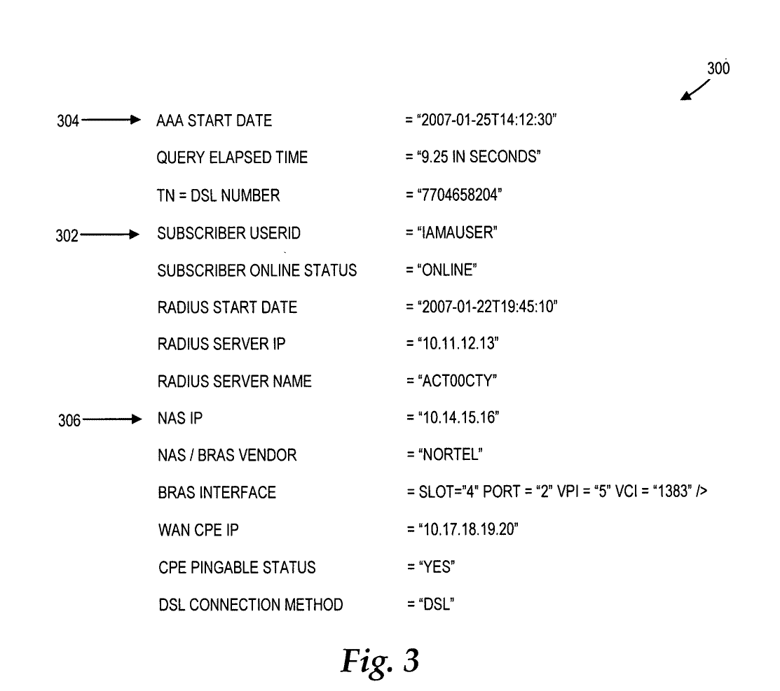

FIG. 3 shows an exemplary XML formatted reply 300 from the RADIUS databases 204, 206, 208, 210 based on a given IP address associated with the subscriber 112. The reply 300 may be formed based on a SQL reply from one or more of the RADIUS databases 204, 206, 208, 210 and formatted into XML by the online status module 214. The reply 300 includes a variety of AAA information, such as a login ID 302, a AAA start time 304, and a NAS IP address 306. If the login ID 302 matches the account of the subscriber 112, then the given IP is verified as being associated with the subscriber 112.

According to exemplary embodiments, intercepted data traffic may be merged with associated AAA data (e.g., a login ID) in order to establish an evidence chain between the intercepted data traffic and the subscriber 112. For example, the intercepted data may be merged with AAA data in accordance with the T1.IAS standard. To this end, the XML formatted reply 300 may be utilized to verify the association between the AAA data and the intercepted data traffic.

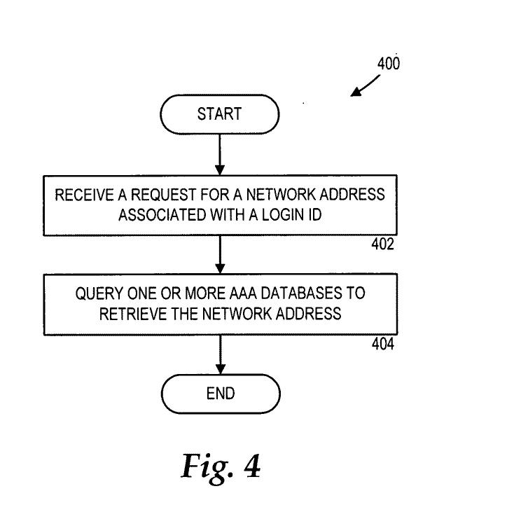

Referring now to FIG. 4, a flow diagram illustrating a method 400 for determining a relationship between a login identifier and a network address in a lawful interception system is shown, in accordance with exemplary embodiments. According to the method 400, the online status module 214 receives (at 402) a request from the mediation system 116 to retrieve a network address based on a login ID associated with the subscriber 112. In one embodiment, the online status module 214 queries (at 404) one or more AAA databases, such as the RADIUS databases 204, 206, 208, 210 to retrieve the network address based on the login ID.

In particular, the online status module 214 may receive an XML formatted request from the mediation system 116. The online status module 214 may generate a SQL request based on the XML formatted request and transmit the SQL request to the AAA databases. Upon transmitting the SQL request, the online status module 214 may receive a SQL reply from the remote database. The SQL reply may include a variety of AAA information, such as the network address associated with the login ID. The network address may include an IP address, for example. The online status module 214 may generate an XML formatted reply based on the SQL reply and transmit the XML formatted reply to the mediation system 116.

Applying Filtering Mechanisms to Dynamically Intercept Data

Once a source identifier associated with the source computer 114 is known, the AF system 102 may be configured to capture data traffic originating from the source identifier. The source identifier may include, but is not limited to, an IP address, Media Access Control (“MAC”) address, PVC, or other suitable Layer 2 (i.e., the data link layer) or Layer 3 (i.e., the network layer) construct.

One approach to capturing data traffic at the subscriber identifier is to utilize a vendor-provided filtering mechanism available on a switch, router, or other hardware. For example, the CATALYST switch from CISCO SYSTEMS INC. provides functionality for a Virtual Local Area Network Access Control List (“VLAN ACL” or “VACL”) capture. The VACLs provide access control for all packets that are bridged within a VLAN or that are routed into or out of a VLAN or a Wide Area Network (“WAN”) interface for VACL capture. The VACLs may be configured to apply various specific rules on intercepts for lawful surveillance, problem diagnostics, and other suitable applications.

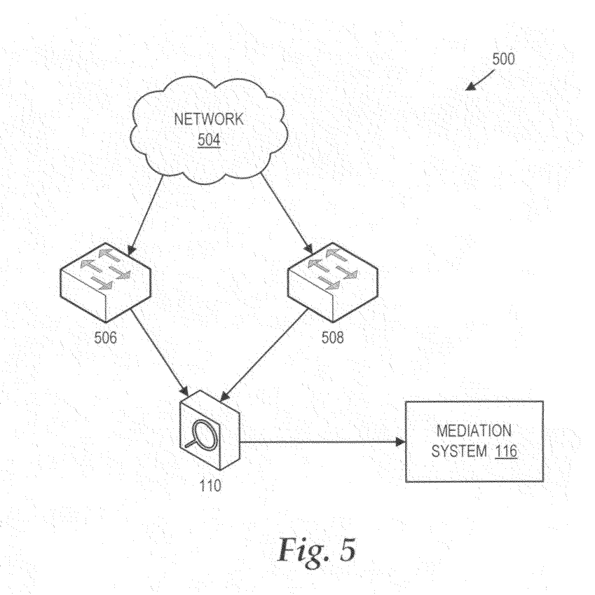

Referring now to FIG. 5, a simplified block diagram illustrating an alternate configuration 500 of the lawful interception system is shown, in accordance with exemplary embodiments. As illustrated in FIG. 5, the configuration 500 includes a first switch 506 and second switch 508. In one embodiment, the first switch 506 and the second switch 508 comprise switches from the CATALYST series of switches from CISCO SYSTEMS INC. Other switches from other vendors may be similarly utilized as contemplated by those skilled in the art. In one embodiment, the first switch 506 and the second switch 508 each provide a vendor-specific filtering mechanism for isolating data traffic based on user-defined rules. For example, the CATALYST series of switches provide VACL capture functionality. The first switch 506 and the second switch 508 may each be located in different locations (e.g., separate cities).

A subscriber, such as the subscriber 112, or other user of the source computer 114 may access a broadband network 504, such as the Internet, via the source computer 114 and either the first switch 506 or the second switch 508. Services for accessing the broadband network 504 include End User Aggregation (“EUA”), Integrated Fiber in the Loop (“IFITL”), wireless Digital Subscriber Line (“DSL”), and the like.

In one embodiment, an ACL is configured to retrieve data traffic that only matches the source identifier associated with the source computer 114. For example, the ACL may include the IP address associated with the subscriber 112. As data traffic arrives at the first switch 506 and the second switch 508, the IP address associated with the data traffic is compared with the information on the ACL. If the IP address associated with the data traffic matches the information on the ACL, then the data traffic may be passed from the first switch 506 and the second switch 508, where it is captured by a probe 510 or other suitable network element, such as another switch for layer 2 (e.g., via RSPAN) or layer 3 transport (e.g., via ERSPAN). If the IP address associated with the data traffic does not match the information on the ACL, then the data traffic can be dropped from the first switch 506 and the second switch 508, and thereby is not captured by the probe 510 or other network element.

The probe 510 may forward the intercepted data traffic to a mediation system 116. In one embodiment, the intercepted data traffic may be backhauled to a centrally located device in the AF system 102. A portion of the intercepted data traffic, such as the IP header information, may be parsed from the intercepted data traffic and forwarded to the mediation system 116, instead of forwarding the entire data stream. By utilizing the VACL capture or other vendor-provided functionality on the first switch 506 and the second switch 508, data traffic associated with a given subscriber identifier can be effectively filtered from other data traffic not covered by a lawful interception order, among other suitable applications.

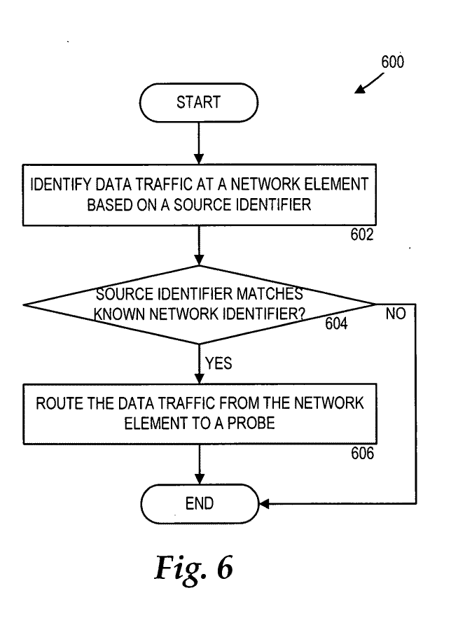

Referring now to FIG. 6, a flow diagram illustrating a method 600 for intercepting data traffic with a lawful interception system is shown, in accordance with exemplary embodiments. According to the method 600, data traffic is identified (at 602) at a network element, such as the first switch 506 and the second switch 508, based on a source identifier associated with the data traffic. For example, the source identifier may be an IP address associated with the source computer 114 from where the data traffic originates.

Upon identifying the data traffic at the network element, the network element compares (at 604) to the source identifier associated with the data traffic with a known network identifier. For example, the known network identifier, such an IP address, may be associated with data traffic for which the network element is configured to intercept.

In one embodiment, the network element utilizes VACL capture functionality, as previous described, or other vendor-provided functionality to identify the relevant data traffic. Upon determining that the source identifier matches the known network identifier, the network element routes (at 606) the data traffic to a probe, such as the probe 110, for interception. In other embodiments, the network element may route the data traffic directly to the mediation system, such as the mediation system 116.

Capturing Data and Forwarding the Data to Location for Analysis

Generally, the T1.IAS standard mandates that a variety of AAA traffic be obtained simultaneously with the interception of data traffic associated with the subscriber 112. Conventionally, the AAA traffic can be obtained via AAA accounting logs. However, this approach to obtaining AAA traffic may not be acceptable due to time of delay (e.g., several minutes to an hour) or the lack of desired information in the AAA accounting logs. As such, a better approach may be to intercept the AAA traffic in real-time or near real-time. At least four techniques are available for enabling real time interception of AAA traffic.

In a first technique, a Fast Ethernet (“FE”) probe or splitter is deployed to each relevant AAA server to intercept all FE links. As such, the number of FE probes is at least the number of relevant AAA servers. For an increasing number of AAA servers, deploying and managing a corresponding number of FE probes becomes expensive and difficult. For this reason, this first technique is generally not preferred.

In an illustrative example, three points of presence (“POPs”) are of interest: a first POP, a second POP, and a third POP. As used herein, a POP refers to a localized group of AAA servers. The first, second, and third POPs each include two AAA servers. Applying the first technique to this example would require the deployment and management of six FE probes—one for each of the AAA servers.

In a second technique, a SPAN is implemented across switch ports associated with each relevant AAA server. Under this configuration, a single FE probe may be deployed to each POP, thereby significantly reducing the number of deployed FE probes compared to the first technique. Deploying and managing FE probes for an increasing number of POPs, however, still present substantial cost and complexity. Turning again to the illustrative example, applying the second technique would require the deployment and management of three FE probes—one for each of the POPs.

In a third technique, a Remote SPAN (“RSPAN”) is implemented across switch ports associated with each relevant AAA server. These switches may be connected via a GigE Wireless Access Network (“WAN”) link, and Layer 2 information may be sent to a central collection point, where the AAA traffic is captured by a single FE probe. While the third technique utilizes fewer probes than the first and second techniques, the third technique may require one or more dedicated WAN links to serve as point-to-point connections between the switches and the central collection point.

In a fourth technique, an Enhanced Remote SPAN (“ERSPAN”) is implemented across switch ports associated with each relevant AAA server. From the switches, the AAA traffic is encapsulated in an IP header and routed via Layer 3 to a central collection point, where the AAA traffic is captured by a single probe. Only data traffic associated with the AAA switch ports are included in the ERSPAN. With ERSPAN, the AAA information is trunked to an IP address instead of a destination port. As such, the ERSPAN may utilize existing WAN infrastructure, subject to normal capacity planning needs.

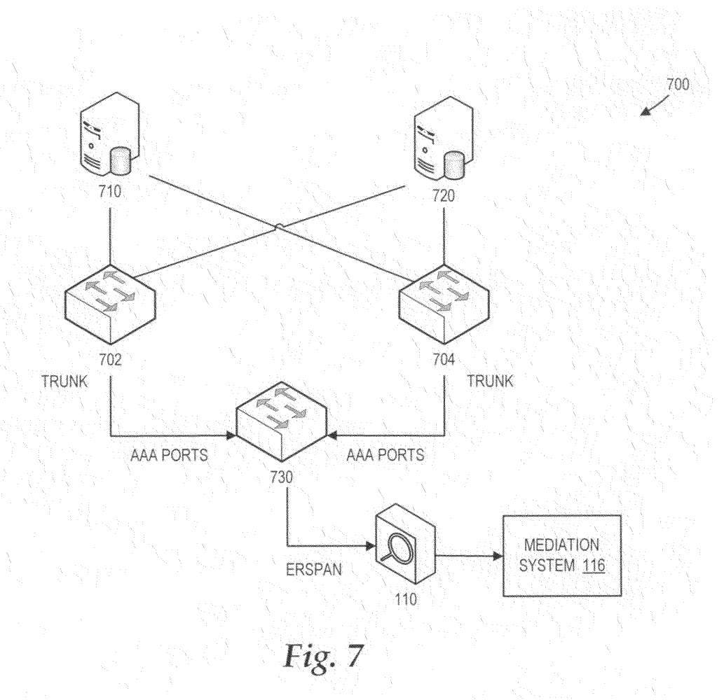

Referring now to FIG. 7, a simplified block diagram illustrating an traffic transport system 700 is shown in accordance with exemplary embodiments. The system 700 utilizes ERSPAN as described in the fourth technique. While the embodiments described below primarily refer to the transport of AAA traffic, it should be appreciated that the system 700 may also be used to transport subscriber traffic in a similar manner. The system 700 includes a first switch 702 and a second switch 704. The first switch 702 and the second switch 704 are each operatively coupled to a first AAA server 710 and a second AAA server 720 in a multi-homed configuration, as illustrated in FIG. 7. In this way, if a connection between a given AAA server and a one switch fails, then another connection between the AAA server and another switch may be available. In one embodiment, the first AAA server is located in a first point of presence (“POP”), and the second AAA server 720 is located in a second POP. In other embodiments, multiple POPs may be configured in a similar manner. In particular, each POP may include multiple AAA servers, each of which is operatively coupled to multiple switches in a multi-homed configuration.

The AAA traffic from the AAA ports in the first switch 702 and the second switch 704 are trunked to a CALEA intercept router 730. By trunking the AAA traffic, IEEE 802.1Q VLAN tags are maintained. Further, trunking the AAA traffic may aid in segmenting the AAA traffic at a later point in the interception process. An example of the router 730 is the CATALYST 6500 series of switches from CISCO SYSTEMS INC. The router 730 may span the data traffic to one or more ports where the probe 110, which is operatively coupled to the router 730, captures the data traffic and forwards the data traffic to the mediation system 116.

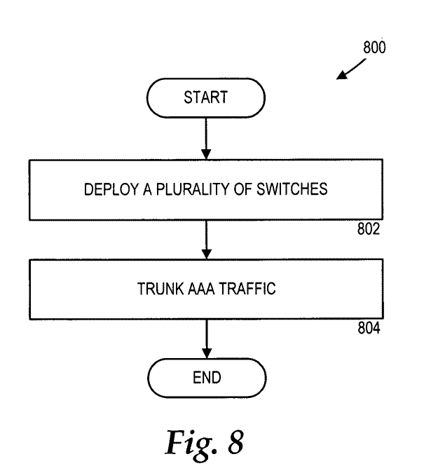

Referring now to FIG. 8, a flow diagram illustrating a method 800 for collecting AAA traffic along with subscriber data traffic is shown, in accordance with exemplary embodiments. According to the method 800, a broadband service provider, for example, may deploy (at 802) a plurality of switches, such as the first switch 702 and the second switch 704. Each of the plurality of switches may be operatively coupled to a plurality of AAA servers. For example, the first switch 702 and the second switch 704 each may be operatively coupled to a first AAA server 710 and a second AAA server 720.

Upon deploying the plurality of switches, AAA traffic from the AAA ports in the plurality switches are trunked (at 804) to a port on a switch or a router, such as the router 730. In particular, any suitable switch or router with routing capability may be utilized. For example, a CISCO CATALYS 6504 switch may be configured with a CISCO SUPERVISOR ENGINE 32 blade for routing capability. In this case, the router serves as a central collection point at which a probe, such as the probe 110 can intercept the AAA traffic. In other embodiments, the traffic can be routed to a central point, at which the traffic can reach a single probe, such as the probe 110, or the mediation system 116 directly. The techniques disclosed in the above embodiments provide a way to intercept AAA traffic from AAA servers located in multiple POPs (e.g., multiple cities) with a single probe, thereby significantly reducing cost.

Applying Filtering Capture Rules on Devices Providing Multi-Homed Network Access

Generally, multi-homing refers to providing an enterprise network with multiple entries to a broadband network, such as the Internet. These redundant entries can provide fault tolerance for applications that require access to the broadband network. A multi-homed network may be provided multiple IP addresses with which to access the broadband network. A challenge with lawful interception is monitoring and intercepting data traffic associated from these multiple IP addresses. In particular, if only a subset of IP addresses in a block of IP addresses are monitored, then data traffic associated with other IP addresses in the block may be detrimentally ignored.

One way to configure a multi-homed network is to utilize multiple routers and switches. In particular, each router may be deployed at a different POP. Embodiments described herein provide for intercepting data traffic at multi-homed networks. In particular, multiple probes may be used to intercept data traffic associated with an IP address or a range of IP addresses as defined by a given court order.

It should be appreciated that the embodiments described herein may not be applicable if network elements (e.g., routers, switches) are used to self-intercept data traffic. In particular, some newer routers have operating system and hardware functionality that support traffic capture directly at the routers without additional equipment, such as probes and splitters. Examples of these newer routers include the GSR 12410 router operating IOS software (e.g., with “K9” IOS image support) from CISCO SYSTEMS INC. and the M320 router operating JUNOS 8.2 or higher software from JUNIPER NETWORKS INC.

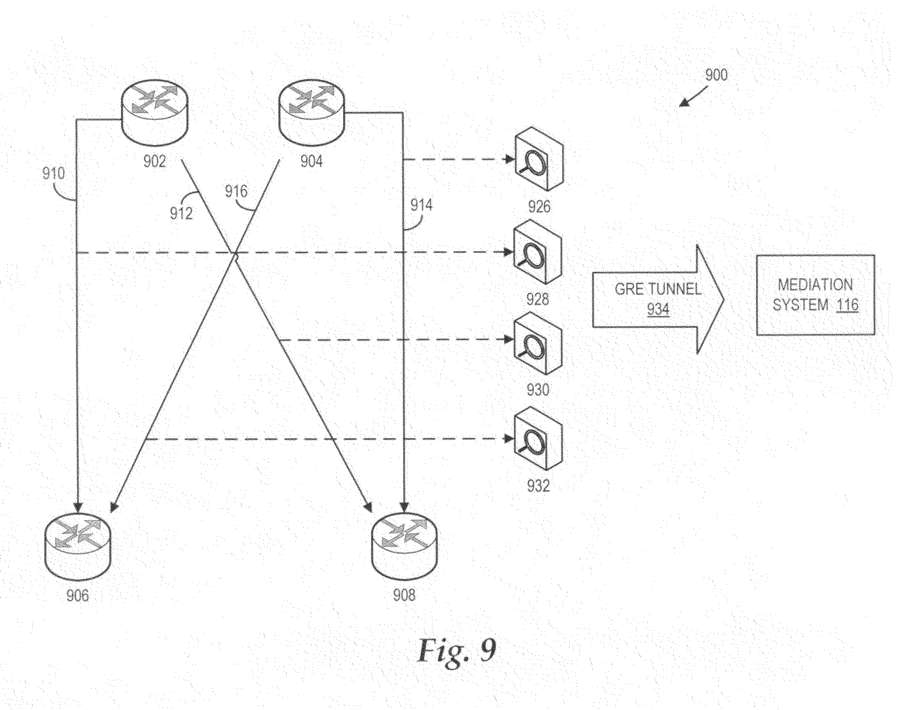

Referring now to FIG. 9, a simplified block diagram illustrating a lawful interception system 900 for capturing data traffic at a multi-homed network is shown, in accordance with exemplary embodiments. The lawful interception system 900 includes a first Provider Edge (“PE”) router 902 and a second PE router 904. In one embodiment, the first PE router 902 is located at a first POP, and the second PE router 904 is located at a second POP. An example of the first PE router 902 and the second PE router 904 is the GSR Series Router from CISCO SYSTEMS INC.

The first PE router 902 is operatively coupled to a first Provider (“P”) router 906 via a first communication link 910 and to a second P router 908 via a second communication link 912. The second PE router 904 is operatively coupled to the first P router 906 via a third communication link 914 and to the second P router 908 via a fourth communication link 916. In one embodiment, the communication links 910, 912, 914, 916 are each Gigabit Ethernet links. Examples of the first P router 906 and the second P router 908 include M series routers from JUNIPER NETWORKS. and a CRS or GSR series routers from CISCO SYSTEMS INC. The operation of PE routers and P routers are well known in the art, and thus are not described in greater detail herein.

In one embodiment, data traffic across the third communication link 914 is adapted to be intercepted by a first probe 926. Data traffic across the first communication link 910 is adapted to be intercepted by a second probe 928. Data traffic across the second communication link 912 is adapted to be intercepted by a third probe 930. Data traffic across the fourth communication link 916 is adapted to be intercepted by a fourth probe 932. In other embodiments, each of the probes 926, 928, 930, 932 is operatively coupled to a splitter (not shown) to enable the interception of data traffic. In particular, the splitters may be adapted to split data traffic across the communication links 910, 912, 914, 916. An example of the splitter is a multi-mode 70/30 splitter from NET OPTICS INC.

The probes 926, 928, 930, 932 may be configured to intercept data traffic for a single IP address or a range of IP addresses for a multi-homed network. In one embodiment, the probes 926, 928, 930, 932 are GigE probes. The intercepted data traffic may be forwarded from the probes 926, 928, 930, 932 to a mediation system 116 via a Generic Routing Encapsulation (“GRE”) tunnel 934, for example.

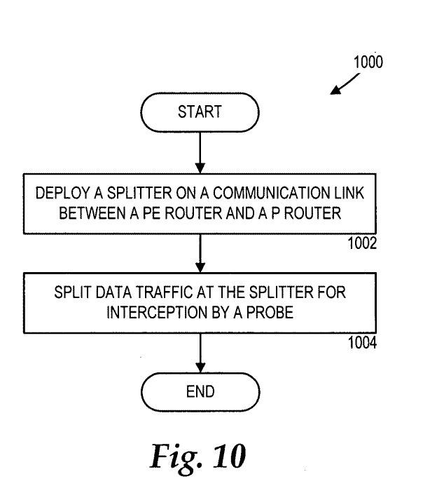

Referring now to FIG. 10, a flow diagram illustrating a method 1000 for collecting AAA traffic along with subscriber data traffic is shown, in accordance with exemplary embodiments. According to the method 1000, a broadband service provider deploys (at 1002 multiple PE routers and P routers, each of the PE routers being operatively coupled to each of the P routers in a multi-homed configuration. Each of the connections between the PE routers and the P routers create a separate communication link. For example, the first PE router 902 forms the first communication link 910 with the first P router 906 and the second communication link 912 with the second P router 908. In a similar manner, the second PE router 904 forms the third communication link 914 with the second P router 908 and the fourth communication link 916 with the first P router 906.

Upon deploying the PE routers 902, 904 and the P routers 906, 908, single probes, such as the probes 926, 928, 930, 932, are deployed to each of the communication links 910, 912, 914, 916 between the PE routers 902, 904 and the P routers 906, 908. The probes 926, 928, 930, 932 enable the interception of data traffic across the communication links 910, 912, 914, 916. As previously described, splitters may be deployed at the communication links 910, 912, 914, 916 to further enable the interception of data traffic across the communication link 910, 912, 914, 916.

Generating Traffic at a Network Device to Test Whether a Lawful Interception System is Operational

In order to test whether a lawful interception system, such as the lawful interception system 100 illustrated in FIG. 1, is operational and correctly intercepts the intended data traffic, known test traffic may be generated. As the known test traffic is transmitted across a broadband network, the lawful interception system can capture the known test traffic. The intercepted data traffic can then be compared with the known test traffic to determine whether the lawful interception system is accurately intercepting the test traffic.

Embodiments described herein utilize vendor-provided functionality in a processor-based network device in order to generate known test traffic. Examples of processor-based network devices include, but are not limited to, a router, a switch, an asynchronous digital subscriber line termination unit remote (“ATUR”), and a cable modem. An example of vendor-provided functionality that can be utilized is the Service Assurance Agent (“SAA”) provided in some routers made by CISCO SYSTEMS INC.

SAA is a CISCO SYSTEMS Internetwork Operating System (“IOS”) feature that generally enables users to monitor network performance between a CISCO SYSTEMS router and a remote device, such as another CISCO SYSTEMS router. In particular, SAA includes a variety of different operations for generating and analyzing data traffic to measure performance between devices. Examples of performance measurements may include round trip response time, connect time, packet loss, application performance, inter-packet delay variance (i.e., jitter), and the like.

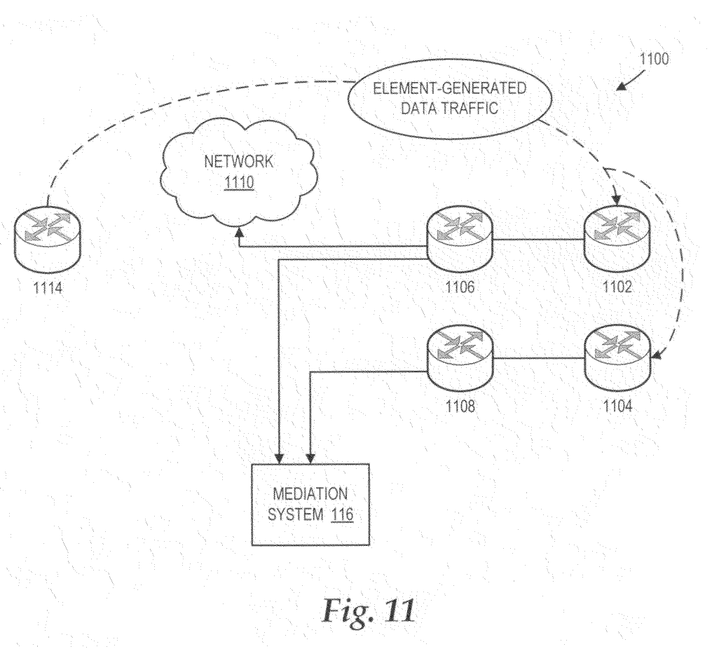

Referring now to FIG. 11, a simplified block diagram illustrating a lawful interception system 1100 is shown, in accordance with exemplary embodiments. In one embodiment, the lawful interception system 1100 is able to intercept data traffic from production DSL “test” lines or other suitable broadband circuit. In other embodiments, the lawful interception system 1100 may be adapted to intercept data traffic from any suitable broadband subscribers. In this way, the lawful interception system 1100 can be tested to ensure that it is fully operational.

In one embodiment, the lawful interception system 1100 is based upon digital subscriber line (“DSL”). One type of broadband service that is commonly offered is digital subscriber line (“DSL”). Different service providers provide different ways to transport DSL products. For example, AT&T SOUTHWEST transports DSL products via three primary methods: (1) End User Access (“EUA”), which is based on a REDBACK SMS 1800 broadband remote access server (“BRAS”); (2) Enhanced End User Access (“EEUA”), which utilizes asynchronous transfer mode (“ATM”) and is based on a NORTEL SERVICES EDGE ROUTER (“SER”) 5500 BRAS; and (3) Competitive Broadband (“CBB”), which utilizes ATM or Ethernet transport and is based on a REDBACK SMARTEDGE (“SE”) 800 BRAS.

Although not so limited, the lawful interception system 1100 illustrates EEUA and CBB. As illustrated in FIG. 11, the lawful interception system 1100 includes a first ADSL modem 1102 and a second ADSL modem 1104. In one embodiment, the first ADSL modem 1102 and the second ADSL modem 1104 are asymmetric digital subscriber line termination unit remotes (“ATURs”). In particular, the first ADSL modem 1102 may be a CISCO 877 ADSL Integrated Services Router, and the second ADSL modem 1104 may be a CISCO 837 ADSL Broadband Services Router.

According to exemplary embodiments, the first ADSL modem 1102 is operatively coupled to a first BRAS 1106, such as the NORTEL SER 5500 BRAS, that operates in EEUA, and the second ADSL modem 1104 is operatively coupled to a second BRAS 1108, such as the REDBACK SE 800 BRAS, that operates in CBB. A first computer (not shown) operatively coupled to the first ADSL modem 1102 may transmit test traffic to a broadband network 1110, such as the Internet, via ATM transport. For example, the first computer may visit a predetermined list of websites to generate the test traffic. Further, the a second computer (not shown) operatively coupled to the second ADSL modem 1104 may transmit test traffic to a third computer (not shown) via IP transport. For example, the second computer may transmit a file via file transfer protocol (“FTP”). It should be appreciated that other suitable configurations of computers and ADSL modems may be similarly utilized.

Also included in the lawful interception system 1100 is a traffic-generating network element 1114. In an illustrative example, the traffic-generating network element 1114 may be a CISCO 7206VXRINPE-G1 Router, which provides SAA functionality as previously described. In one embodiment, the traffic-generating network element 1114 is configured to generate and transmit data traffic at the broadband network 1110 via the first ADSL modem 1102 and the first BRAS 1106 and/or at the third computer via the second ADSL modem 1104 and the second BRAS 1108. For example, the CISCO 7206VXR/NPE-G1 Router may be configured to generate and transmit a variety of protocol-based data traffic, such as Lightweight Directory Application Protocol (“LDAP”) traffic, Simple Mail Transfer Protocol (“SMTP”) traffic, Post Office Protocol 3 (“POP3”) traffic, and Network News Transfer Protocol (“NNTP”) traffic.

While SAA is conventionally utilized to generate data traffic for the purpose of performance monitoring, the embodiments described herein adapt the SAA functionality for generating test traffic for purposes of testing a lawful interception system. Other functionality provided by CISCO and non-CISCO network devices can be similarly utilized, as contemplated by those skilled in the art. By utilizing the additional data traffic that can be generated by the traffic-generating network element 1114, a typical DSL subscriber can be better emulated.

The lawful interception system 1100 further includes the mediation system 116. The mediation system 116 receives intercepted data traffic from the first BRAS 1106 and the second BRAS 1108 via any suitable interception technique or device, such as a probe or a network element. The data traffic intercepted at the mediation system 116 may be utilized for a variety of purposes. For example, the intercepted data traffic may be compared to the original data traffic to verify the accuracy of the lawful interception system.

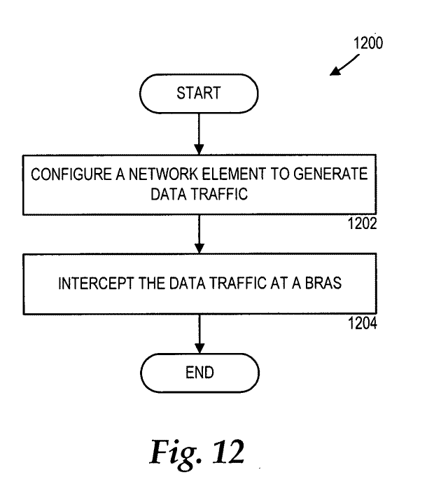

Referring now to FIG. 12, a flow diagram illustrating a method 1200 for generating data traffic to test a lawful interception system is shown, in accordance with exemplary embodiments. According to the method 1200, the mediation system 116 configures (at 1202) a network element, such as the traffic-generating network element 1114, to generate data traffic. In particular, the network element may generate the data traffic via vendor-provided functionality, such as SAA functionality, built into the network element or via a suitable computer attached to the network element using a third party application, such as IXIA CHARIOT. Upon configuring the network element to generate data traffic, the BRAS intercepts (at 1204) the data traffic at the BRAS and forwards the intercepted data traffic to the mediation system 116.

Removing Trace Data from Known, Safe, and/or Operational Sources

The evolution of DSL service from legacy fiber in the loop (“FITL”) and older BRAS platforms (e.g., NORTEL SER 5500 routers) to modern BRAS platforms (e.g., REDBACK SE 800 routers) may require an adaptation of lawful interception systems. For example, modern BRAS platforms may provide that all broadband DSL subscriber data traffic pass across the BRAS regardless of the type of digital subscriber line access multiplexer (“DSLAM”) being implemented (e.g., optical or electrical).

Further, modern BRAS platforms, such as the REDBACK SE 800 routers, enable the interception of subscriber data traffic based on subscriber username, IP address, circuit ID, and other suitable subscriber identifier. However, in order to enable this functionality on modern BRAS platforms, the DSLAM must also provide the subscriber identifier. Only modern DSLAMs, such as the ALCATEL 7330 series, provide the subscriber identifier. Assuming a given DSLAM can provide the subscriber identifier and the BRAS platform is capable of intercepting subscriber data traffic based on the subscriber identifier, lawful interception based on the subscriber identifier may be preferred since it seldom changes.

Lawful interception based on the subscriber identifier may create a number of different issues. One issue may be the separation of subscriber Internet traffic, which may be covered by an interception order, and other data traffic, which may not be covered by the interception order. For example, other data traffic may include data traffic being received from a known, safe source or being transmitted to a known, safe destination. In the case of Internet Protocol Television (“IPTV”) and Video on Demand (“VOD”), for example, which are often provided by the same service provider that provides broadband network access, IPTV and VOD may be provided at the same port as the broadband network (e.g., port 80).

Embodiments described herein provide for the separation of relevant data traffic (e.g., subscriber Internet traffic) from extraneous data traffic (e.g., IPTV traffic, VOD traffic). In one embodiment, the extraneous data traffic is filtered based on source or destination IP address. For example, a service provider that provides IPTV and VOD will know the IP address of the servers transmitting the IPTV and VOD signals. Thus, the extraneous data traffic can be filtered from intercepted data traffic in order to leave only relevant data traffic.

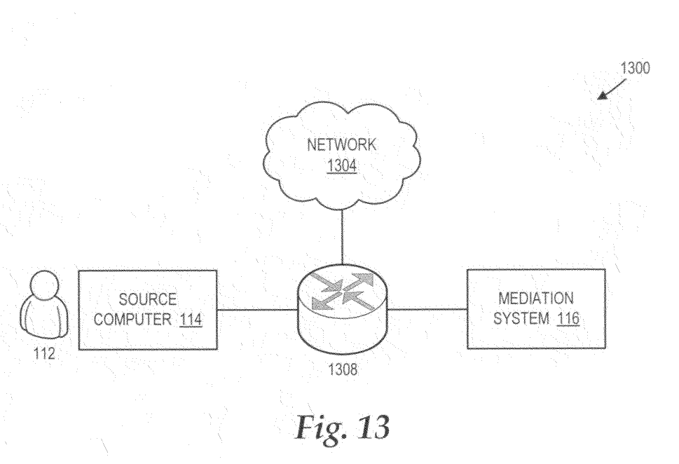

Referring now to FIG. 13, a simplified block diagram illustrating a lawful interception system 1300 is shown, in accordance with exemplary embodiments. In the lawful interception system 1300, the subscriber 112 or other user of the source computer 114 accesses a broadband network 1304, such as the Internet, via the source computer 114 and a BRAS 1308. An example of the BRAS 1308 is the REDBACK SE 800 router. In one embodiment, the BRAS 1308 is configured to intercept all broadband data traffic at given IP address, subscriber username, or circuit ID. Further, data traffic being transmitted to and from known IP addresses associated with IPTV, VOD, and other safe sources and destinations may be excluded by filters on the mediation system 116. In this way, broadcast data traffic (i.e., IPTV and VOD traffic) can be excluded from the relevant data traffic.

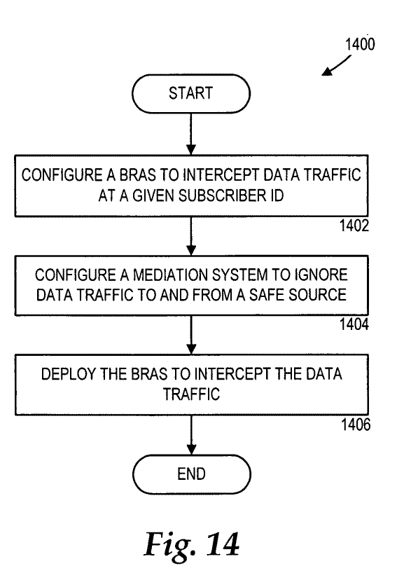

Referring now to FIG. 14, a flow diagram illustrating a method 1400 for filtering extraneous data traffic in a lawful interception system is shown, in accordance with exemplary embodiments. According to the method 1400, the mediation system 116 configures (at 1402) a BRAS, such as the BRAS 1308, to intercept data traffic at a given subscriber identifier. For example, the subscriber identifier may be an IP address associated with the source computer 114.

The mediation system 116 further configures (at 1404) a mediation system, such as the mediation system 116, to ignore data traffic transmitted to or received from a safe source. In an illustrative example, the mediation system 116 may be configured to ignore data traffic that is transmitted to or received from certain IP addresses associated with IPTV, VOD, and other content broadcast by the broadband service provider. In this way, extraneous data traffic can be filtered from the relevant data traffic prior to transmission to law enforcement. Upon configuring the BRAS 1308 to intercept data traffic at a given subscriber identifier and the mediation system 116 to ignore data traffic transmitted to or received from a safe source, the BRAS 1308 may be deployed (at 1406) to intercept the data traffic.

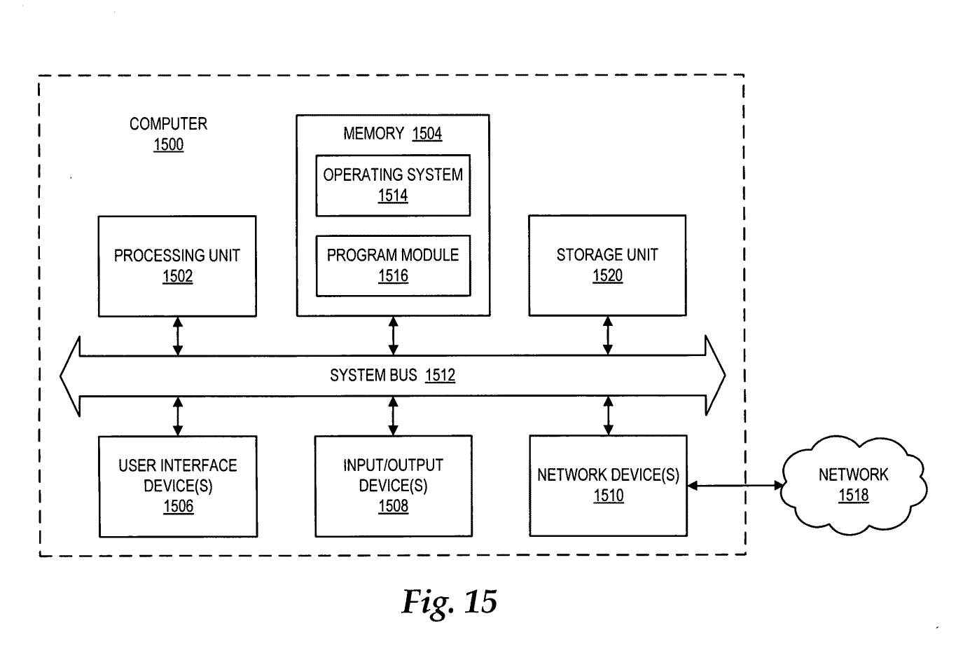

FIG. 15 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 15 is a block diagram illustrating a computer 1500, in accordance with exemplary embodiments. Examples of the computer 1500 may include the source computer 114 and the mediation system 116. The computer 1500 includes a processing unit 1502, a memory 1504, one or more user interface devices 1506, one or more input/output (“I/O”) devices 1508, one or more network devices 1510, and the storage unit 1520, each of which is operatively connected to a system bus 1512. The bus 1512 enables bi-directional communication between the processing unit 1502, the memory 1504, the user interface devices 1506, the I/O devices 1508, the network devices 1510, and the storage unit 1520.

The processing unit 1502 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 1504 communicates with the processing unit 1502 via the system bus 1512. In one embodiment, the memory 1504 is operatively connected to a memory controller (not shown) that enables communication with the processing unit 1502 via the system bus 1512. The memory 1504 includes an operating system 1514 and at least one program module 1516, according to exemplary embodiments. Examples of operating systems, such as the operating system 1514, include, but are not limited to, WINDOWS operating system from MICROSOFT CORPORATION, LINUX operating system, MAC OS from APPLE CORPORATION, and FREEBSD operating system. The program module 1516 may be adapted to perform one or more of the methods 400, 600, 800, 1000, 1200, 1400 described in greater detail above. In one embodiment, the program module 1516 is embodied in computer-readable media containing instructions that, when executed by the processing unit 1502, performs one or more of the methods 400, 600, 800, 1000, 1200, 1400. According to further embodiments, the program module 1516 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 1500.

The user interface devices 1506 may include one or more devices with which a user accesses the computer 1500. The user interface devices 1506 may include, but are not limited to, computers, servers, personal digital assistants, cellular phones, or any suitable computing devices. The I/O devices 1508 enable a user to interface with the program module 1516. In one embodiment, the I/O devices 1508 are operatively connected to an I/O controller (not shown) that enables communication with the processing unit 1502 via the system bus 1512. The I/O devices 1508 may include one or more input devices, such as, but not limited to, a keyboard, a mouse, or an electronic stylus. Further, the I/O devices 1508 may include one or more output devices, such as, but not limited to, a display screen or a printer.

The network devices 1510 enable the computer 1500 to communicate with other networks or remote systems via a network 1518. Examples of the network devices 1510 may include, but are not limited to, a modem (e.g., an ATUR), a radio frequency (“RF”) or infrared (“IR”) transceiver, a telephonic interface, a bridge, a router, or a network card. The network 1518 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 1518 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for lawfully intercepting broadband data traffic, comprising:
receiving a request to retrieve a network address associated with a login identifier;
querying an Authentication, Authorization and Accounting (AAA) server based on the login identifier to retrieve the network address associated with the login identifier;
filtering relevant data traffic and AAA information associated with the relevant data traffic at a network element; and
forwarding the relevant data traffic and the AAA information to a law enforcement agency (LEA) system.

2. The method of claim 1, wherein filtering relevant data traffic and AAA information associated with the relevant data traffic at a network element comprises:
identifying data traffic at a network element based on a source identifier associated with the data traffic;
comparing the source identifier to a network identifier included in an access control list (ACL) provided by a network element;
determining that the source identifier matches the network identifier if the source identifier matches the network identifier specified in the ACL; and
upon determining that the source identifier matches the network identifier, intercepting the data traffic associated with the source identifier.

3. The method of claim 2, wherein filtering relevant data traffic and AAA information associated with the relevant data traffic at a network element further comprises removing safe data traffic from the intercepted data traffic.

4. The method of claim 3, wherein removing safe data traffic from the intercepted data traffic comprises ignoring data traffic being transmitted to or received from a safe Internet Protocol (IP) address.

5. The method of claim 1, wherein filtering relevant data traffic and AAA information associated with the relevant data traffic at a network element comprises retrieving the AAA information associated with the relevant data traffic by monitoring an AAA port at a switch operatively coupled to the AAA server.

6. The method of claim 1, wherein the network address is an Internet Protocol (IP) address, and wherein the IP address is dynamically assigned.

7. The method of claim 1, wherein querying a AAA server based on the login identifier to retrieve the network address associated with the login identifier comprises:
generating a Standard Query Language (SQL) request based on an Extensible Markup Language (XML) formatted request;
transmitting the SQL request to the AAA server;
upon transmitting the SQL request, receiving a SQL reply from the AAA server;
generating a XML formatted reply based on the SQL reply; and
transmitting the XML formatted reply to a mediation function.

8. A system for lawfully intercepting broadband data traffic, comprising:
a memory for storing a program containing code for lawfully intercepting broadband data traffic;
a processor functionally coupled to the memory, the processor being responsive to computer-executable instructions contained in the program and operative to:
receive a request to retrieve a network address associated with a login identifier,
query an Authentication, Authorization and Accounting (AAA) server based on the login identifier to retrieve the network address associated with the login identifier,
filter relevant data traffic and AAA information associated with the relevant data traffic at a network element, and
forward the relevant data traffic and the AAA information to a law enforcement agency (LEA) system.

9. The system of claim 8, wherein to filter relevant data traffic and AAA information associated with the relevant data traffic at a network element, the processor is further operative to:
identify data traffic at a network element based on a source identifier associated with the data traffic,
compare the source identifier to a network identifier included in an access control list (ACL) provided by a network element,
determine that the source identifier matches the network identifier if the source identifier matches the network identifier specified in the ACL, and
upon determining that the source identifier matches the network identifier, intercept the data traffic associated with the source identifier.

10. The system of claim 9, wherein to filter relevant data traffic and AAA information associated with the relevant data traffic at a network element, the processor is further operative to remove safe data traffic from the intercepted data traffic.

11. The system of claim 10, wherein to remove safe data traffic from the intercepted data traffic, the processor is further operative to ignore data traffic being transmitted to or received from a safe Internet Protocol (IP) address.

12. The system of claim 8, wherein to filter relevant data traffic and AAA information associated with the relevant data traffic at a network element, the processor is further operative to retrieve the AAA information associated with the relevant data traffic by monitoring an AAA port at a switch operatively coupled to the AAA server.

13. The system of claim 8, wherein the network address is an Internet Protocol (IP) address, and wherein the IP address is dynamically assigned.

14. A computer-readable medium having instructions stored thereon for execution by a processor to provide a method for lawfully intercepting broadband data traffic, the method comprising:
receiving a request to retrieve a network address associated with a login identifier;
querying an Authentication, Authorization and Accounting (AAA) server based on the login identifier to retrieve the network address associated with the login identifier;
filtering relevant data traffic and AAA information associated with the relevant data traffic at a network element; and
forwarding the relevant data traffic and the AAA information to a law enforcement agency (LEA) system.

15. The computer-readable medium of claim 14, wherein filtering relevant data traffic and AAA information associated with the relevant data traffic at a network element comprises:
identifying data traffic at a network element based on a source identifier associated with the data traffic;
comparing the source identifier to a network identifier included in an access control list (ACL) provided by a network element;
determining that the source identifier matches the network identifier if the source identifier matches the network identifier specified in the ACL; and
upon determining that the source identifier matches the network identifier, intercepting the data traffic associated with the source identifier.

16. The computer-readable medium of claim 15, wherein filtering relevant data traffic and AAA information associated with the relevant data traffic at a network element further comprises removing safe data traffic from the intercepted data traffic.

17. The computer-readable medium of claim 16, wherein removing safe data traffic from the intercepted data traffic comprises ignoring data traffic being transmitted to or received from a safe Internet Protocol (IP) address.

18. The computer-readable medium of claim 14, wherein filtering relevant data traffic and AAA information associated with the relevant data traffic at a network element comprises retrieving the AAA information associated with the relevant data traffic by monitoring an AAA port at a switch operatively coupled to the AAA server.

19. The computer-readable medium of claim 14, wherein the network address is an Internet Protocol (IP) address, and wherein the IP address is dynamically assigned.

20. The computer-readable medium of claim 14, wherein querying a AAA server based on the login identifier to retrieve the network address associated with the login identifier comprises:
generating a Standard Query Language (SQL) request based on an Extensible Markup Language (XML) formatted request;
transmitting the SQL request to the AAA server;
upon transmitting the SQL request, receiving a SQL reply from the AAA server;
generating a XML formatted reply based on the SQL reply; and
transmitting the XML formatted reply to a mediation function.
